(19) United States
(12) Patent Application Publication
(10) Pub. No.: US 2010/0110824 A1
(43) Pub. Date: May 6, 2010

(54) DISPERSION/STIRRING APPARATUS AND DISPERSION TANK

(75) Inventors: Yushi Hirata, Osaka (JP); Daisuke Nishi, Tatsuno-shi (JP); Mitsuru Fujikawa, Hyogo (JP)

Correspondence Address: DARBY & DARBY P.C., P.O. BOX 770, Church Street Station, New York, NY, 10008-0770, US

(73) Assignee: Kabushiki Kaisha Teikoku Denki Seisakusho, Tatsuno-shi (JP)

(21) Appl. No.: 12/595,778

(22) PCT Filed: May 13, 2008
(86) PCT No.: PCT/JP2008/058758

§ 371 Date: Oct. 13, 2009

(30) Foreign Application Priority Data
May 18, 2007 (JP) 2007-132254

(51) Int. Cl. B01F 3/00

(52) U.S. Cl. 366/133

(57) ABSTRACT

A dispersion/stirring apparatus that is capable of micronizing gas dispersed and stirred into a liquid in a tank without requiring a separate pump or a stirring device is provided. The rotation unit is provided with a flow path that opens at an inner diameter side as well as an outer diameter side of the rotation unit. The flow path is provided with a flow path expansion portion at which the flow path expands in the direction towards the outer diameter side of the rotation unit. The flow path expansion portion of the rotation unit has an effect similar to that of a Venturi tube and thereby enables micronization of a gas. Rotation of the rotation unit produces a pump effect and a stirring effect, thereby eliminating the need of providing a separate pump or stirring device.

### CROSS-REFERENCE TO PRIOR APPLICATION

This is the U.S. National Phase Application under 35 U.S.C. §371 of International Patent Application No. PCT/JP2008/058758 filed May 13, 2008, which claims the benefit of Japanese Patent Application No. 2007-132254 filed May 18, 2007, both of which are incorporated by reference herein. The International Application was published in Japanese on Nov. 27, 2008 as WO2008/143056 A1 under PCT Article 21(2).

### TECHNICAL FIELD

The present invention relates to a dispersion/stirring apparatus used for dispersing and stirring a fluid. The invention further relates to a dispersion tank that uses the dispersion/stirring apparatus.

### BACKGROUND OF THE INVENTION

In some industrial fields recently, such as the field of dispersing gas in liquid and stirring the resultant gas-liquid mixture, the demand is increasing for gas micronization in response to greater diversification of processes or in order to promote the efficiency and progress of related reactions.

An example of conventional dispersion/stirring apparatuses includes a liquid container, a star-shaped impeller disposed in the bottom part of the container, and a stationary unit containing the impeller, wherein the impeller is supported by a vertically extending shaft so as to rotate with the vertical shaft. A gas supply pipe is provided in the vicinity of the lower face of the impeller, and a gas outlet is provided at an outer circumferential part of the impeller. A liquid supply portion is provided in order to supply liquid to the end face of the impeller. The gas sucked into the impeller as a result of rotation of the impeller is released from the gas outlet into a flow path of the stationary unit and subsequently discharged into the liquid in the container through a pipe that is connected to the flow path of the stationary unit (e.g. See Japanese Laid-open Patent Publication No. 6-182379 (p 5, and FIGS. 1 and 2)).

However, a dispersion/stirring apparatus having such a structure described above, wherein bubbles discharged into the liquid have large diameters, is not capable of responding to the demand for micronizing the gas.

Examples of methods for micronizing a gas include those that require providing a pipeline with a Venturi tube. This method utilizes a phenomenon in which a gas contained in a liquid is micronized due to the difference in pressure between a constricted portion and an enlarged flow path portion when the liquid flows through a Venturi tube (e.g. See Japanese Laid-open Patent Publication No. 2007-843 (pp 3 and 4, and FIGS. 1 and 2)).

According to conventional methods and structures, however, using a Venturi tube requires a separate pump or the like to deliver the liquid into the Venturi tube, as well as a stirring device or other appropriate device so that the fluid containing ultrafine bubbles that is discharged from the Venturi tube into a reaction tank is uniformly dispersed into the tank.

As described above, conventional dispersion/stirring apparatus have a problem in that they are not capable of responding to the demand for micronizing the gas, because bubbles discharged into the liquid have large diameters. Another problem presented by conventional dispersion/stirring apparatuses is that using a Venturi tube requires a separate pump or the like to deliver the liquid into the Venturi tube, as well as a stirring device or other appropriate device so that the fluid containing ultrafine bubbles that is discharged from the Venturi tube into a reaction tank is uniformly dispersed into the reaction tank. In order to solve the problems described above, an object of the invention is to provide a dispersion/stirring apparatus that is capable of micronizing a fluid and also capable of dispersing and stirring the micronized fluid. Another object of the invention is to provide a dispersion tank equipped with this dispersion/stirring apparatus.

### SUMMARY OF THE INVENTION

A dispersion/stirring apparatus according to the present invention has a rotation unit and includes a flow path and a flow path expansion portion. The flow path opens at an inner diameter side as well as an outer diameter side of the rotation unit, thereby enabling fluid communication between the exterior and the interior of the rotation unit. The flow path expansion portion is provided so that the flow path expands in the direction towards the outer diameter side of the rotation unit.

According to the present invention, the rotation unit of the dispersion/stirring apparatus as above includes a plurality of disks that face one another, and the flow path and the flow path expansion portion are provided between these disks.

According to the present invention, the dispersion/stirring apparatus includes a fixed member facing the rotation unit, and the flow path as well as the flow path expansion portion are provided between the rotation unit and the fixed member. According to the present invention, the flow path of the dispersion/stirring apparatus in any one of the above is provided with a porous member, at a location between the flow path expansion portion and the inner diameter side of the rotation unit.

According to the present invention, the rotation unit of the dispersion/stirring apparatus is provided with a centrifugal fin between either the inner diameter side and the flow path expansion portion or the outer diameter side and the flow path expansion portion, or between the inner diameter side and the flow path expansion portion, as well as between the outer diameter side and the flow path expansion portion. According to the present invention, an end of the rotation unit of the dispersion/stirring apparatus faces upward and is provided with a hole that communicates with the interior and the exterior of the rotation unit.

A dispersion/stirring apparatus according to the present invention has a rotation unit and a stationary unit provided outside the outer diameter side of the rotation unit, and includes a flow path and a flow path expansion portion. The flow path opens at an inner diameter side as well as an outer diameter side of the stationary unit, thereby enabling fluid communication of the exterior and the interior of the stationary unit. The flow path expansion portion is provided so that the flow path expands in the direction towards the outer diameter side of the stationary unit. According to the present invention, either one of or both the rotation unit and the stationary unit of the dispersion/stirring apparatus are provided with a porous member. The porous member provided in the stationary unit is positioned between the flow path expansion portion of the flow path and the inner diameter side of the stationary unit.

According to the present invention, the stationary unit of the dispersion/stirring apparatus as above covers the rotation unit, and a hole is formed in the top surface of the stationary unit.

According to the present invention, the dispersion/stirring apparatus includes a stirring fin provided outside the stationary unit and adapted to rotate integrally with the rotation unit.

According to the present invention, the dispersion/stirring apparatus includes a stirring fin provided on the outer surface of the rotation unit.

According to the present invention, the dispersion/stirring apparatus includes a canned motor for rotating the rotation unit.

A dispersion tank according to the present invention includes a tank for retaining a fluid, and a dispersion/stirring apparatus as described above. The dispersion/stirring apparatus is provided at least at the bottom or the side of the tank and adapted to disperse and stir into the fluid retained in the tank a fluid that is different from the fluid retained in the tank.

According to the present invention, the dispersion tank includes an external cyclic path and a pump. The external cyclic path serves to remove the fluid retained in the tank out of the tank and return the removed fluid into the tank. The pump serves to circulate the fluid retained in the tank through the external cyclic path.

A dispersion tank according to the present invention includes a tank, an external cyclic path, a pump, and a dispersion/stirring apparatus. The tank serves as a reservoir. The external cyclic path serves to remove the fluid retained in the tank out of the tank and return the remove fluid into the tank. The pump serves to circulate the fluid retained in the tank to the external cyclic path. The dispersion/stirring apparatus is provided in the external cyclic path and serves to disperse and stir into the fluid circulating through the external cyclic path a fluid that is different from the fluid circulating through the external cyclic path.

According to the present invention, the dispersion tank above includes a delivery path for delivering to a next process a part of the fluid discharged from the tank into the external cyclic path.

According to the present invention, the dispersion tank as in any one of the above embodiments includes a fluid supply path and a fluid cyclic path. The fluid supply path serves to supply a fluid, which is different from and has a specific gravity lower than that of the fluid retained in the tank, to the dispersion/stirring apparatus. The fluid cyclic path serves to return to the dispersion/stirring apparatus a fluid that is different from and has separated upward from the fluid retained in the tank.

The flow path expansion portion formed as a part of the flow path of the rotation unit has an effect similar to that of a Venturi tube. Therefore, the dispersion/stirring apparatus is capable of micronizing a fluid passing through the flow path and also capable of dispersing and stirring the micronized fluid.

The flow path expansion portion formed as a part of the flow path, which is provided between the plurality of disks of the rotation unit, has an effect similar to that of a Venturi tube. Therefore, while having the same effect as that of the dispersion/stirring apparatus above, this dispersion/stirring apparatus is capable of micronizing a fluid passing through the flow path and also capable of dispersing and stirring the micronized fluid.

According to the present invention, the flow path expansion portion formed as a part of the flow path, which is provided between the rotation unit and the fixed member, has an effect similar to that of a Venturi tube. Therefore, while having the same effect as that of the dispersion/stirring apparatus above, the dispersion/stirring apparatus of this embodiment of the present invention is capable of micronizing a fluid passing through the flow path and also capable of dispersing and stirring the micronized fluid. According to the present invention, the flow path is provided with a porous member at a location between the flow path expansion portion and the inner diameter side of the rotation unit. Therefore, while having the same effect as that of the dispersion/stirring apparatus as discussed above, the dispersion/stirring apparatus of the present invention is capable of ensuring satisfactory contact between two or more kinds of fluids and also increasing pressure in the diametrically inner part of the flow path with respect to the flow path expansion portion, i.e. the part between the flow path expansion portion and the inner diameter end of the flow path, thereby enabling dissolution of a fluid, resulting in more reliable micronization of a fluid passing through the flow path.

According to the present invention, the rotation unit is provided with a centrifugal fin between either the inner diameter side and the flow path expansion portion or the outer diameter side and the flow path expansion portion, or between the inner diameter side and the flow path expansion portion, as well as between the outer diameter side and the flow path expansion portion. Therefore, while having the same effect as that of the dispersion/stirring apparatus as above, the dispersion/stirring apparatus of the present invention ensures more reliable passage of a fluid without the need of a separate pump, because the rotation unit itself has functions and effects identical to those achieved by a centrifugal pump impeller.

An end of the rotation unit faces upward and is provided with a hole that communicates with the interior and the exterior of the rotation unit. Therefore, while having the same effect as that of the dispersion/stirring apparatus as in any one of the embodiments above, the dispersion/stirring apparatus of the present invention is capable of discharging gas remaining in the rotation unit from the hole.

Furthermore, should an excessive quantity of the fluid to be dispersed be fed, the excess fluid flows out of the rotation unit through the hole, consequently enabling monitoring of an appropriate amount of the supply of the fluid to be dispersed.

The flow path expansion portion formed as a part of the flow path of the stationary unit has an effect similar to that of a Venturi tube. Therefore, the dispersion/stirring apparatus is capable of micronizing a fluid discharged from the rotation unit and passing through the flow path of the stationary unit and also capable of dispersing and stirring the micronized fluid.

The flow path is provided with a porous member at a location between the flow path expansion portion and the inner diameter side of the stationary unit. Therefore, while having the same effect as that of the dispersion/stirring apparatus as discussed above, the dispersion/stirring apparatus of the present invention is capable of ensuring satisfactory contact between two or more kinds of fluids and also increasing pressure in the diametrically inner part of the flow path with respect to the flow path expansion portion, i.e. the part between the flow path expansion portion and the inner diameter end of the flow path, thereby enabling dissolution of a fluid, resulting in more reliable micronization of a fluid passing through the flow path. According to the present invention, a hole is formed in the top surface of the stationary unit covering the rotation unit. Therefore, while having the same effect as that of the dispersion/stirring apparatus as disclosed above, the dispersion/stirring apparatus of the present invention is capable of preventing the generation of cavitation as well as preventing failure of function of the rotation unit by discharging gas remaining in the stationary unit from the hole. Furthermore, should an excessive quantity of the fluid to be dispersed be fed, the excess fluid flows out of the rotation unit through the hole, consequently enabling monitoring of an appropriate amount of the supply of the fluid to be dispersed.

A stirring fin is provided outside the stationary unit and adapted to rotate integrally with the rotation unit. Therefore, while having the same effect as that of the dispersion/stirring apparatus as in any one of the above embodiments, the dispersion/stirring apparatus of the present embodiment enables more reliable stirring of a fluid without the need of a separate stirring device.

The rotation unit is provided with a stirring fin so that the rotation unit itself has a stirring function. Therefore, while having the same effect as above, the dispersion/stirring apparatus of the present invention enables more reliable stirring of a fluid without the need of a separate stirring device.

While having the same effect as that of the dispersion/stirring apparatus as claimed in any one of the embodiments above, the dispersion/stirring apparatus of the present invention is, because of characteristics of the canned motor, free from the problem of fluid leakage and, therefore, can be installed at any location and used in a high-temperature, high-pressure or high-vacuum system.

The tank of the dispersion tank is provided with a dispersion/stirring apparatus, which is capable of dispersing and stirring into the fluid retained in the tank a fluid that is different from the fluid retained in the tank. Furthermore, as the dispersion/stirring apparatus includes a canned motor, the dispersion/stirring apparatus can be positioned at the bottom or the side of the tank of the tank. Therefore, in cases where a motor is provided at the upper part of the tank, a maintenance space above the tank for performing maintenance would be unnecessary, such a maintenance space being otherwise required to remove the shaft of the dispersion/stirring apparatus. Furthermore, with a conventional dispersion tank, micronizing a fluid by using a Venturi tube requires a separate pump and a stirring device. However, as there is no need of a separate pump or a stirring device, the present invention is capable of realizing an inexpensive dispersion tank.

While having the same effect as that of the dispersion tank above, this dispersion tank enables more reliable stirring of the fluid retained in the tank, because of the effect of the external cyclic path in addition to the stirring function by the dispersion/stirring apparatus.

According to the present invention, the external cyclic path of the dispersion tank enables circulation and stirring of the fluid retained in the tank, and the dispersion/stirring apparatus provided in the external cyclic path disperses and stirs into the fluid circulating through the external cyclic path a fluid that is different from the fluid circulating through the external cyclic path.

While having the same effect as that of the dispersion tank above, the dispersion tank of the present invention is also capable of delivering, by means of the delivery path, to a next process a part of the fluid discharged from the tank into the external cyclic path.

While having the same effect as that of the dispersion tank as above, the dispersion tank of the present invention is capable of supplying, through the fluid supply path, a fluid, which is different from and has a specific gravity lower than that of the fluid retained in the tank, to the dispersing/stirring apparatus, and is also capable of returning, by means of the fluid cyclic path, to the dispersion/stirring apparatus a fluid that is different from and has separated upward from the fluid retained in the tank. Therefore, reuse of the fluid to be dispersed is possible, and the consumption efficiency of the fluid to be dispersed is improved, resulting in improved efficiency of the entire system.

### BRIEF DESCRIPTION OF THE DRAWINGS

FIG. 1 is a sectional view of a dispersion/stirring apparatus and a dispersion tank according to an embodiment of the present invention.

FIG. 2 is a bottom view of a flow path of a rotation unit of the aforementioned dispersion/stirring apparatus.

FIG. 3 shows a dispersion/stirring apparatus according to another embodiment of the present invention, wherein (a) is a sectional view illustrating the part where the rotation unit is provided, and (b) is a bottom view illustrating the flow path of the rotation unit.

FIG. 4 shows a dispersion/stirring apparatus according to a further embodiment of the present invention, wherein (a) is a sectional view illustrating the part where the rotation unit is provided, and (b) is a bottom view illustrating the flow path of the rotation unit.

FIG. 5 shows a dispersion/stirring apparatus according to yet another embodiment of the present invention, wherein (a) is a sectional view illustrating the part where the rotation unit is provided, and (b) is a bottom view illustrating the flow path of the rotation unit.

FIG. 6 shows a dispersion/stirring apparatus according to an embodiment of the present invention, wherein (a) is a sectional view illustrating the part where the rotation unit is provided, and (b) is a bottom view illustrating the flow path of the rotation unit.

FIG. 7 shows a dispersion/stirring apparatus according to a further embodiment of the present invention, wherein (a) is a sectional view illustrating the part where the rotation unit is provided, and (b) is a bottom view illustrating the flow path of the rotation unit.

FIG. 8 shows a dispersion/stirring apparatus according to yet another embodiment of the present invention, wherein (a) is a sectional view illustrating the part where the rotation unit is provided, and (b) is a bottom view illustrating the flow path of the rotation unit.

FIG. 9 shows a dispersion/stirring apparatus according to an embodiment of the present invention and is a sectional view illustrating the part where the rotation unit is provided.

FIG. 10 shows a dispersion/stirring apparatus according to another embodiment of the present invention and is a sectional view illustrating the part where the rotation unit is provided.

FIG. 11 shows a dispersion/stirring apparatus according to a further embodiment of the present invention, wherein (a) is a sectional view illustrating the part where the rotation unit is provided, and (b) is a bottom view illustrating the flow path of the rotation unit.

FIG. 12 shows a dispersion/stirring apparatus according to an embodiment of the present invention, wherein (a) is a sectional view illustrating the part where the rotation unit is provided, and (b) is a bottom view illustrating the flow path of the rotation unit.

FIG. 13 shows a dispersion/stirring apparatus according to another embodiment of the present invention and is a sectional view illustrating the part where the rotation unit is provided.

FIG. 14 shows a dispersion/stirring apparatus according to a further embodiment of the present invention, wherein (a) is a sectional view illustrating the part where the rotation unit and the stationary unit are provided, and (b) is a sectional view illustrating the flow paths of the rotation unit and the stationary unit viewed from the bottom side.

FIG. 15 shows a dispersion/stirring apparatus according to yet another embodiment of the present invention, wherein (a) is a sectional view illustrating the part where the rotation unit and the stationary unit are provided, and (b) is a sectional view illustrating the flow paths of the rotation unit and the stationary unit viewed from the bottom side.

FIG. 16 shows a dispersion/stirring apparatus according to an embodiment of the present invention, wherein (a) is a sectional view illustrating the part where the rotation unit and the stationary unit are provided, and (b) is a sectional view illustrating the flow paths of the rotation unit and the stationary unit viewed from the bottom side.

FIG. 17 shows a dispersion/stirring apparatus according to a further embodiment of the present invention, wherein (a) is a sectional view illustrating the part where the rotation unit and the stationary unit are provided, and (b) is a sectional view illustrating the flow paths of the rotation unit and the stationary unit viewed from the bottom side.

FIG. 18 shows a dispersion/stirring apparatus according to another embodiment of the present invention, wherein (a) is a sectional view illustrating the part where the rotation unit and the stationary unit are provided, and (b) is a sectional view illustrating the flow paths of the rotation unit and the stationary unit viewed from the bottom side.

FIG. 19 shows a dispersion/stirring apparatus according to an embodiment of the present invention and is a sectional view illustrating the part where the rotation unit and the stationary unit are provided.

FIG. 20 is a sectional view of a dispersion tank according to a further embodiment of the present invention.

FIG. 21 is a sectional view of a dispersion tank according to an embodiment of the present invention.

### DETAILED DESCRIPTION OF THE INVENTION

Next, the present invention is explained in detail hereunder, referring to the drawings.

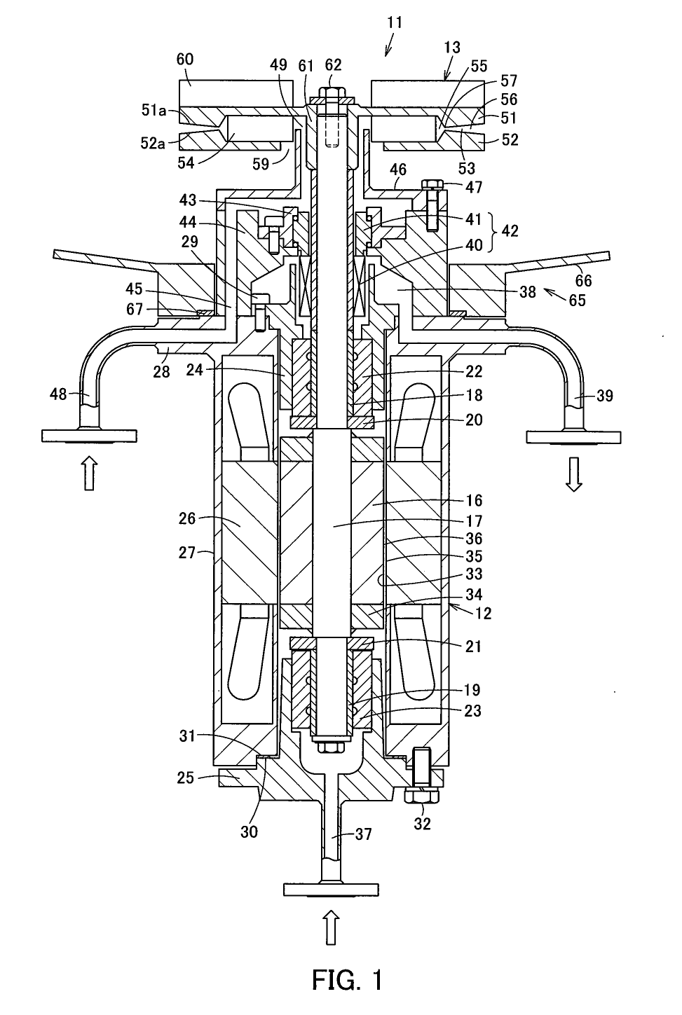

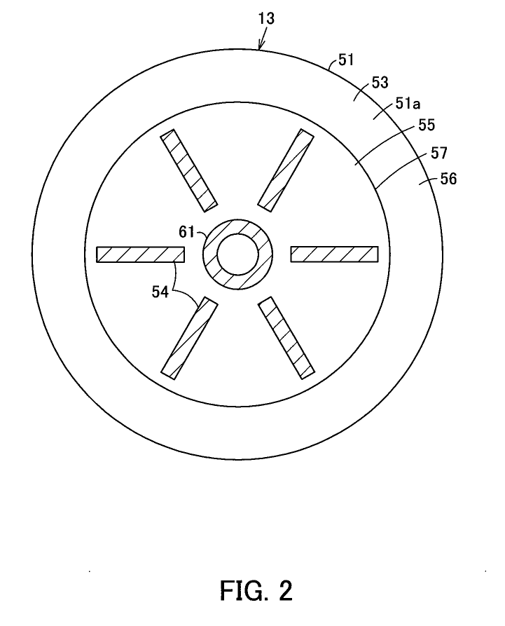

An embodiment of the present invention is shown in FIGS. 1 and 2, wherein FIG. 1 is a sectional view of a dispersion/stirring apparatus and a dispersion tank, and FIG. 2 is a bottom view of a flow path of a rotation unit of the dispersion/stirring apparatus.

Referring to FIG. 1, the dispersion/stirring apparatus 11 includes a canned motor 12 and a rotation unit 13, which is an impeller.

The canned motor 12 includes a rotor 16 and a rotary shaft 17, which is inserted into the rotor 16 and fixed therein. A sleeve 18 and a thrust collar 20 are attached to the front end portion of the rotary shaft 17, and a sleeve 19 and a thrust collar 21 are attached to the rear end portion of the rotary shaft 17. The rotary shaft 17 is rotatably supported through the sleeves 18,19 and the thrust collars 20,21 by bearings 22,23, which are respectively provided at the front end portion and the rear end portion of the rotary shaft 17. The bearings 22,23 are inserted and fixed in a front bearing box 24 and a rear bearing box 25, respectively.

The front bearing box 24 is fastened by means of a bolt 29 to the surface of a front flange 28 of a stator frame 27, in which a stator 26 is placed and fixed. The rear bearing box 25 is fastened in a fluid-tight state by means of a bolt 32 to the rear end face 31 of the stator frame 27, with a gasket 30 between the rear bearing box 25 and the rear end face 31.

The rotor 16 includes a nonmagnetic rotor can 33, which has a thin-walled cylindrical shape, and end plates 34 welded to the rotor can 33 in a fluid-tight state. The stator 26 includes a nonmagnetic stator can 35, which has a thin-walled cylindrical shape and is welded to an end of the stator frame 27 in a fluid-tight state. The rotor 16 and the stator 26 are positioned so that the stator 26 surrounds the rotor 16 with a can gap 36 therebetween.

The rear bearing box 25 has a lubricating liquid inlet 37, which is formed as an integral body with the rear bearing box 25. A lubricating liquid flow path 38 is formed in the front flange 28 of the stator frame 27 and communicates with the front bearing box 24. The front flange 28 is also provided with a lubricating liquid outlet 39, which communicates with the lubricating liquid flow path 38.

The rotary shaft 17 is provided with a mechanical seal. The mechanical seal includes a rotary ring 40 that is fixed to the rotary shaft 17 and adapted to rotate together with the rotary shaft 17. The mechanical seal also includes a fixed ring 41 on which the rotating rotary ring 40 slides. The rotary ring 40 and the fixed ring 41 together form a shaft sealing portion 42. Although the mechanical seal is used in this embodiment, the mechanical seal may be omitted, depending on conditions. Furthermore, it is also possible to use other sealing means, such as a gland packing, an O-ring, an oil seal, a VF seal, etc.

Through a fixed ring support 43, the fixed ring 41 of the mechanical seal is fixed to a shaft sealing portion support 44, which is fastened in a fluid-tight state by means of a bolt to the surface of the front flange 28 of the stator frame 27.

A fluid passage forming member 46, which is a hollow tubular member that forms a fluid passage 45, is fastened by means of a bolt 47 to the shaft sealing portion support 44. The fluid passage 45 is formed by the gap between the rotary shaft 17 and the fluid passage forming member 46, and the gap between the fluid passage forming member 46 and the shaft sealing portion support 44; and a flow path formed in the shaft sealing portion support 44 and in the front flange 28 of the stator frame 27. A fluid inlet 48 communicating with the fluid passage 45 is formed in the front flange 28 of the stator frame 27. Between the end of the fluid passage forming member 46 and the rotary shaft 17, a fluid outlet 49 communicating with the fluid passage 45 is formed at the inner diameter side of the rotation unit 13.

Referring to FIGS. 1 and 2, the rotation unit 13 includes two disks 51,52, between which a circumferentially uninterrupted flow path 53 is formed. A plurality of radially arranged centrifugal fins 54 for connecting the disks 51,52 are provided in the flow path 53. The centrifugal fins 54 are positioned towards the center of the flow path 53.

Tapered portions 51a,52a facing the flow path 53 are formed on the opposing surfaces of the respective disks 51,52, at a location between centrifugal fins 54 and the outer diameter end of the disks 51,52. The tapered portions 51a,52a are inclined so that the gap therebetween flares outward, towards the outer diameter end of the disks 51,52. As a result, the flow path 53 includes a flow path contraction portion 55 around the centrifugal fins 54, in other words at a location between the centrifugal fins 54 and the outer diameter end of the flow path 53, and a flow path expansion portion 56 around the flow path contraction portion 55, i.e. between the flow path reduction portion 55 and the outer diameter end of the flow path 53. In other words, the flow path 53, i.e. the gap between the disks 51,52, narrows at the flow path contraction portion 55 in the direction towards the outer diameter end and expands at the flow path expansion portion 56 in the direction towards the outer diameter end. Furthermore, a minimum gap portion 57 at which the flow path 53, i.e. the gap between the disks 51,52, is the narrowest is provided between the flow path contraction portion 55 and the flow path expansion portion 56.

One of the two disks, i.e. the disk 52, is disposed closer to the canned motor 12 than is the other disk, i.e. the disk 51. Formed in the central part of the disk 52 is a liquid inlet 59, which is open to the outside of the disk 52.

The disk 51 is positioned further from the canned motor 12 than is the disk 52. A plurality of radially arranged stirring fins 60 are provided on and project from the externally facing planar surface of the disk 51. A boss 61 attached to the rotary shaft 17 of the canned motor 12 is formed at the central part of the disk 51.

The rotation unit 13 is fastened by means of a bolt 62 to the front end of the rotary shaft 17 of the canned motor 12. Thus, the dispersion/stirring apparatus 11 comprises the canned motor 12 and the rotation unit 13.

Referring to FIG. 1, a dispersion tank 65 includes a tank 66 for retaining a first fluid, such as a liquid. The dispersion tank 65 serves to disperse and stir in the first fluid a second fluid that is different from the first fluid. The second fluid contains at least one fluid that is a gas, a liquid that is not soluble in the liquid in the tank 66, or a liquid that contains bubbles. The front flange 28 of the stator frame 27 of the canned motor 12 is fastened in a fluid-tight state by means of a bolt (not shown) to the bottom of the tank 66, with a gasket 67 therebetween. Thus, the dispersion/stirring apparatus 11 is attached to the tank of the dispersion tank 65 in such a state that the rotation unit 13 is disposed in the tank 66.

Next, how the dispersion/stirring apparatus 11 operates is explained, referring to FIGS. 1 and 2.

The explanation hereunder is given based on the assumption that the fluid retained in the tank 66 is a liquid and that the fluid to be dispersed and stirred in the liquid in the tank 66 by the dispersion/stirring apparatus 11 is a gas.

The lubricating liquid supplied to the canned motor 12 is introduced from the lubricating liquid inlet 37 to lubricate and cool the bearings 23 at the rear portion of the rotary shaft 17. The lubricating liquid subsequently flows through the can gap 36 to cool the rotor 16 and the stator 26, lubricates and cools the bearings 22 at the front portion of the rotary shaft 17, and is then discharged from the lubricating liquid outlet 39.

A minute part of the lubricating liquid serves to smooth rotational sliding of the rotary ring 40 on the fixed ring 41 of the mechanical seal and flows out of the shaft sealing portion 42 into the fluid passage 45. In cases where the liquid in the tank 66 is used as the lubricating liquid, no problems occur should a part of the lubricating liquid flows out into the fluid passage 45, in other words into the tank 66.

When the gas is introduced from the fluid inlet 48, the gas is fed through the fluid passage 45 into the central part of the rotation unit 13.

When the rotary shaft 17 of the canned motor 12 rotates, the rotation unit 13, too, rotates integrally with the rotary shaft 17 so that the liquid in the tank 66 is introduced from the liquid inlet 59 of the rotation unit 13. As a result, the mixture of the gas and the liquid passes through the flow path contraction portion 55 and the flow path expansion portion 56 of the flow path 53 of the rotation unit 13 sequentially and is discharged out of the rotation unit 13. When the mixture of the gas and the liquid passes through the flow path contraction portion 55 and subsequently through the flow path expansion portion 56, the change of the dimension of the flow path causes a change in the flow velocity, and consequently the pressure, of the gas-liquid mixture, resulting in micronization of the gas in the liquid.

The degree of micronization of the gas largely depends on the flow velocity and quantity of the gas, as well as the respective dimensions of the flow path 53 at the minimum gap portion 57 and the flow path expansion portion 56. For example, if the flow velocity of the gas exceeds a certain threshold, it is impossible to reduce bubbles of the gas to a sufficiently small diameter, resulting in insufficient micronization. Should this be the case, the diameter of bubbles to which the gas is micronized can be adjusted primarily by the respective dimensions of the flow path 53 at the minimum gap portion 57 and the flow path expansion portion 56. Should the flow velocity of the gas be less than the threshold, the gas can be micronized into ultrafine bubbles of a sufficiently small dimension.

As described above, the flow path expansion portion 56 formed as a part of the flow path 53 of the rotation unit 13 has an effect similar to that of a Venturi tube so that the gas can be micronized as a result of the liquid containing the gas passing through the flow path 53 of the rotation unit 13. Furthermore, as the disks 51,52 have functions and effects identical to those achieved by a pump impeller, the liquid can pass between the disks 51,52 without the need of a separate pump.

Furthermore, because of the centrifugal fins 54 provided at a location between the flow path expansion portion 56 and the inner diameter side of the rotation unit 13, the rotation unit 13 itself has functions and effects identical to those achieved by a centrifugal pump impeller. Therefore, the rotation unit 13 is capable of passing the liquid therethrough even more reliably without the need of a separate pump.

Furthermore, the stirring fins 60 provided on the outer surface of the rotation unit 13 enable, without the need of a separate stirring device, greater reliability for stirring the gas-containing liquid in the tank 66.

The outer surface of the rotation unit 13 on which the stirring fins 60 are provided is not limited to the externally facing planar surface of the disk 51 but also includes the externally facing planar surface of the disk 52 and the outer circumferential surfaces of the disks 51,52 so that the stirring fins 60 may be provided on any of these surfaces.

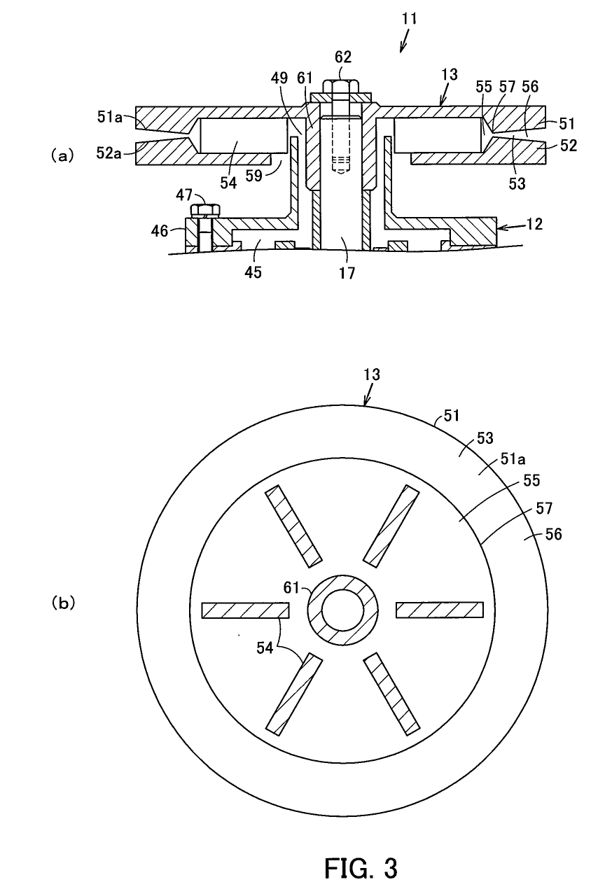

Next, another embodiment of the present invention is shown in FIG. 3, wherein FIG. 3 (a) is a sectional view illustrating the part where the rotation unit is provided, and FIG. 3 (b) is a bottom view illustrating the flow path of the rotation unit.

This embodiment has the same structure as found in the first embodiment shown in FIGS. 1 and 2, except that this embodiment does not include the stirring fins 60.

Although the stirring fins 60 are not provided, the flow of the liquid discharged from the rotation unit 13 and the rotating disks 51,52 are capable of stirring the liquid in the tank 66.

Depending on conditions, such as the property of the liquid in the tank 66, dimensions of the tank 66, etc., the present embodiment has sufficient functions and effects regardless of the absence of the stirring fins 60.

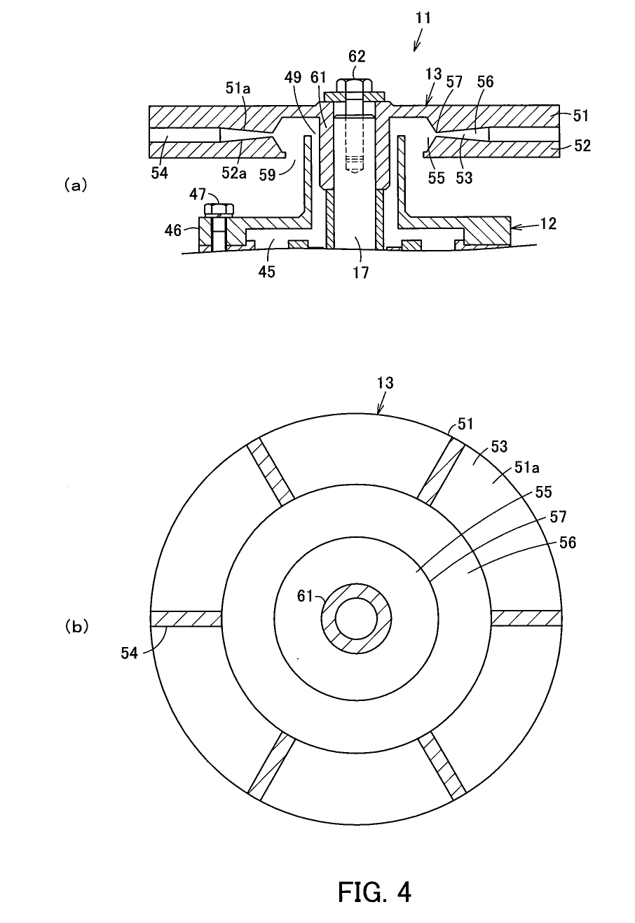

Next, a further embodiment of the present invention is shown in FIG. 4, wherein FIG. 4 (a) is a sectional view illustrating the part where the rotation unit is provided, and FIG. 4 (b) is a bottom view illustrating the flow path of the rotation unit.

This embodiment has the same structure as found in the previous embodiment shown in FIG. 3, except that the centrifugal fins 54 are formed between the flow path expansion portion 56 and the outer diameter side of the rotation unit 13.

The structure according to this embodiment of the invention is able to achieve the same functions and effects as can be done by the previous embodiment of the invention shown in FIG. 3. A particular benefit of this embodiment lies in that the centrifugal fins 54 formed closer to the outer diameter side of the rotation unit 13 generate greater centrifugal force and consequently produce improved centrifugal effect.

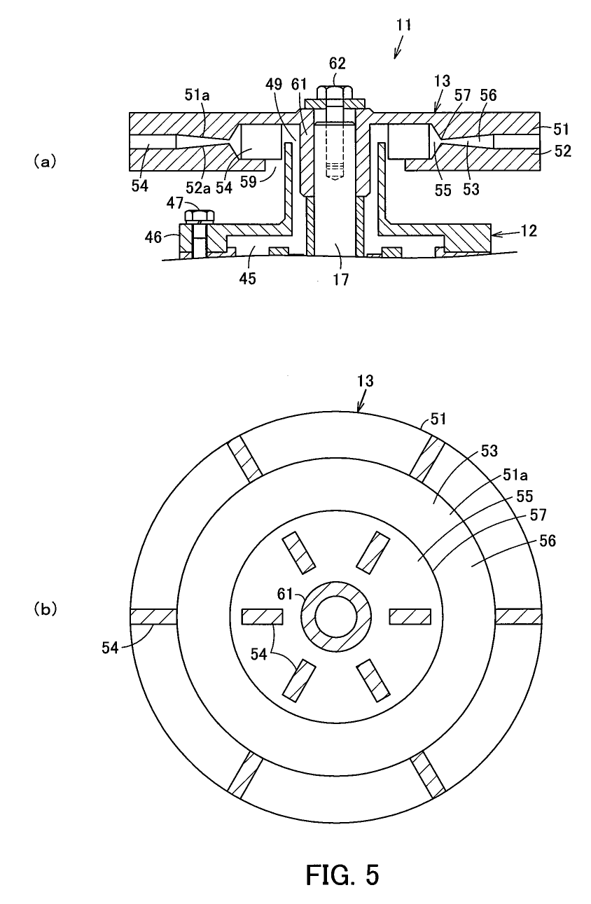

Next, an embodiment of the present invention is shown in FIG. 5, wherein FIG. 5 (a) is a sectional view illustrating the part where the rotation unit is provided, and FIG. 5 (b) is a bottom view illustrating the flow path of the rotation unit.

The embodiment has the same structure as found in the other embodiment shown in FIG. 3, except that the centrifugal fins 54 are formed between the inner diameter side and the flow path expansion portion 56, as well as between the outer diameter side and the flow path expansion portion 56.

Such a structure enables a mixture of liquid and gas to flow with greater reliability into the rotation unit 13. A particular benefit of this embodiment lies in that the centrifugal fins 54 formed closer to the outer diameter side of the rotation unit 13 generate greater centrifugal force and consequently produce improved centrifugal effect.

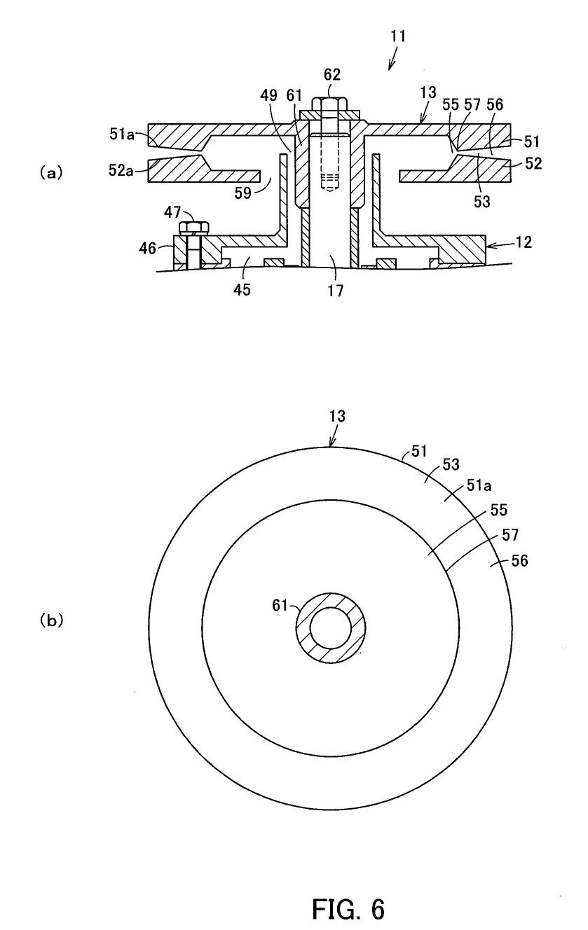

Next, another embodiment of the present invention is shown in FIG. 6, wherein FIG. 6 (a) is a sectional view illustrating the part where the rotation unit is provided, and FIG. 6 (b) is a bottom view illustrating the flow path of the rotation unit.

This embodiment has the same structure as found in the embodiment shown in FIGS. 1 and 2, except that this fifth embodiment does not include the centrifugal fins 54 or the stirring fins 60. In the case of this embodiment, providing a separate structure to connect the disks 51,52 together enables the disks 51,52 to be integrally rotated.

Although the centrifugal fins 54 are not provided, the rotation unit 13 achieves an effect identical to that by a pump so that the liquid can be introduced into the rotation unit 13 by rotating the rotation unit 13.

Although the stirring fins 60 are not provided, the flow of the liquid discharged from the rotation unit 13 and the rotating disks 51,52 are capable of stirring the liquid in the tank 66.

Depending on conditions, such as the property of the liquid in the tank 66, dimensions of the tank 66, etc., the present embodiment has sufficient functions and effects regardless of the absence of the centrifugal fins 54 and the stirring fins 60.

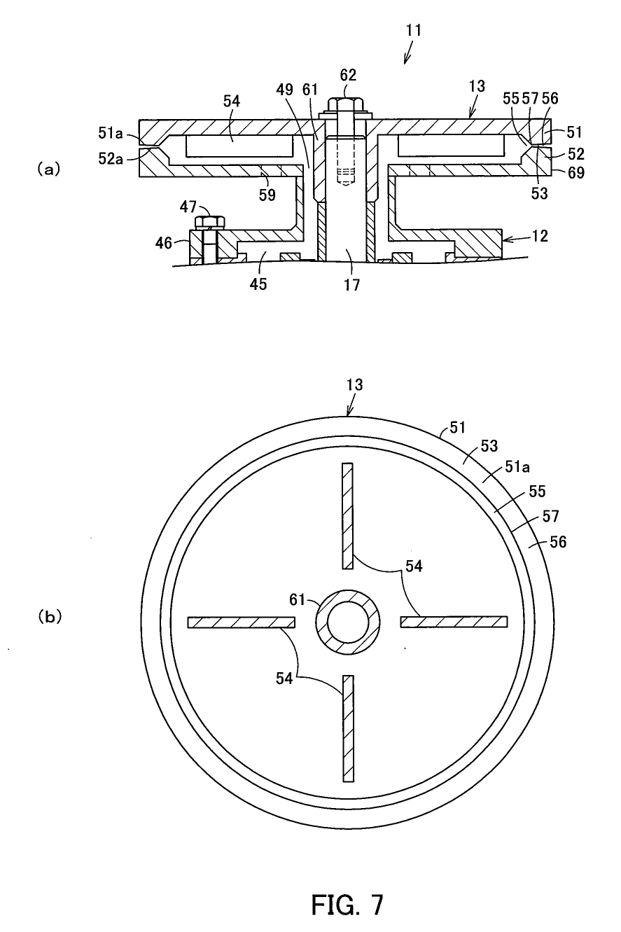

Next, a further embodiment of the present invention is shown in FIG. 7, wherein FIG. 7 (a) is a sectional view illustrating the part where the rotation unit is provided, and FIG. 7 (b) is a bottom view illustrating the flow path of the rotation unit.

This embodiment has the same structure as found in the embodiment shown in FIG. 3, except that the disk 52 is separated from the disk 51 and formed as a fixed member 69 fixed to the fluid passage forming member 46 of the canned motor 12.

The inner circumferential portion of the disk 52 that formed as the fixed member 69 is fixed to the fluid passage forming member 46, and a plurality of liquid inlets 59 are formed near the inner circumferential portion of the disk 52.

With the structure as above, driving the canned motor 12 rotates only the disk 51, and the disk 52 does not rotate. However, a strong liquid shearing force field is generated in the flow path 53, resulting in shearing flow, which, in addition to expanded flow caused by the flow path expansion portion 56, enables micronizion of bubbles.

The same effects can be achieved by reversing the structure of the disks 51,52 of the embodiment, in other words providing the upper disk 51 as the fixed member 69 so that the lower disk 52 alone is capable of rotating.

The centrifugal fins 54 and/or the stirring fins 60 may be provided on the upper disk 51 of the rotation unit 13, or, as in the fifth embodiment shown in FIG. 6, the rotation unit 13 may not be provided with centrifugal fins 54 or stirring fins 60.

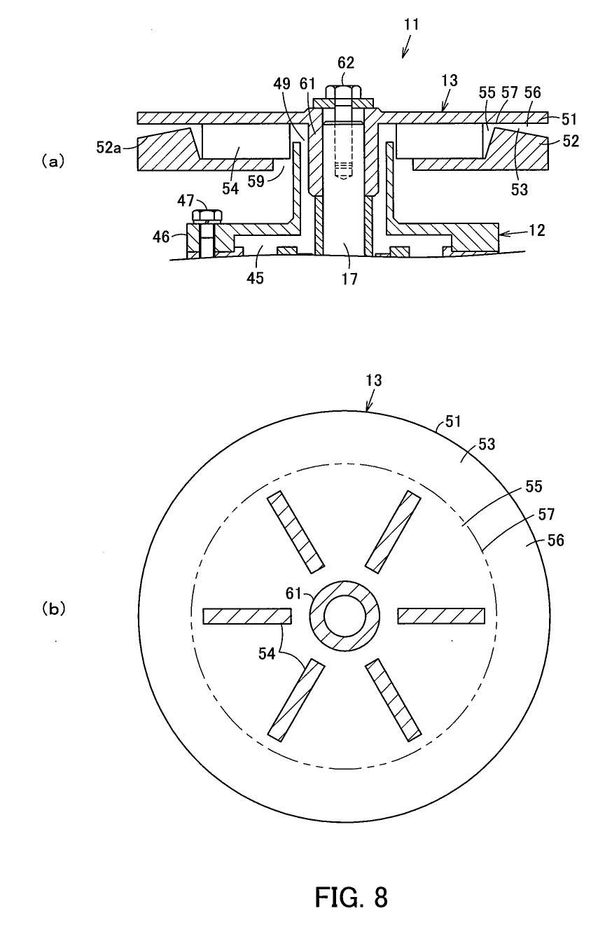

Next, an embodiment of the present invention is shown in FIG. 8, wherein FIG. 8 (a) is a sectional view illustrating the part where the rotation unit is provided, and FIG. 8 (b) is a bottom view illustrating the flow path of the rotation unit.

This embodiment has the same structure as found in the embodiment shown in FIG. 3, with the exception of a modification made to the flow path 53.

According to this embodiment, the flow path expansion portion 56 is formed by providing only one of the disks, i.e. the lower disk 52, with a tapered portion 52a. This structure is able to not only achieve the same functions and effects as can be done by the above embodiment of the invention shown in FIG. 3 but also provides a further benefit in that it facilitates production of the rotation unit 13.

In FIG. 8, the lower disk 52 alone is provided with a tapered portion 52a. However, a structure wherein the upper disk 51 alone is provided with a tapered portion achieves the same effects.

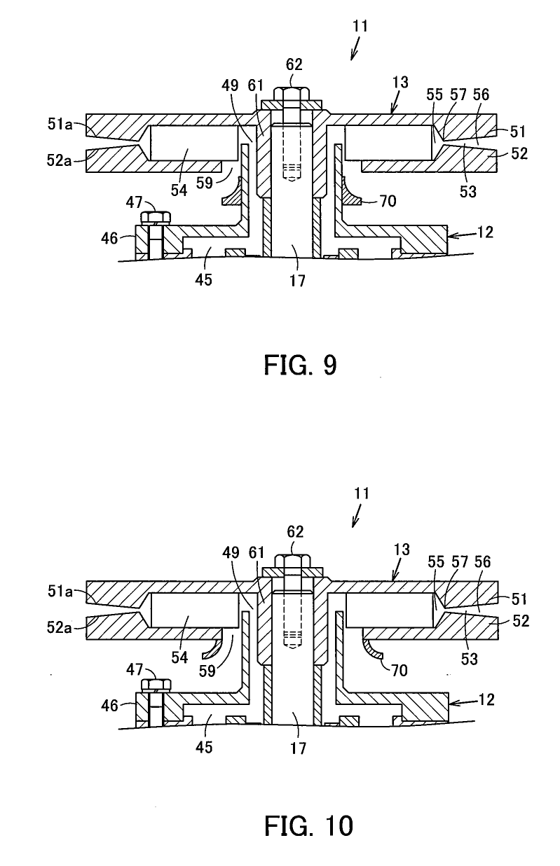

Next, an embodiment of the present invention is shown in FIG. 9, which is a sectional view illustrating the part where the rotation body is provided.

The embodiment has the same structure as found in the embodiment shown in FIG. 3, except that a guide portion 70 is provided along the outer circumferential surface of the fluid passage forming member 46, which is a stationary portion facing the liquid inlet 59 of the rotation unit 13. The guide portion 70 serves to guide and thereby facilitate flow of the liquid being introduced into the liquid inlet 59 as a result of rotation of the rotation unit 13.

As the guide portion 70 enables the liquid to flow into the liquid inlet 59 of the rotation unit 13 smoothly, it is possible to increase the discharge rate of the liquid from the outer circumferential portion of the rotation unit 13. Next, another embodiment of the present invention is shown in FIG. 10, which is a sectional view illustrating the part where the rotation body is provided.

This embodiment has the same structure as found in the embodiment shown in FIG. 3, except that a guide portion 70 is provided along the outer diameter end of the liquid inlet 59 of the rotation unit 13. The guide portion 70 serves to guide and thereby facilitate flow of the liquid being introduced into the liquid inlet 59 as a result of rotation of the rotation unit 13.

As the guide portion 70 enables the liquid to flow into the liquid inlet 59 of the rotation unit 13 smoothly, it is possible to increase the discharge rate of the liquid from the outer diameter portion of the rotation unit 13.

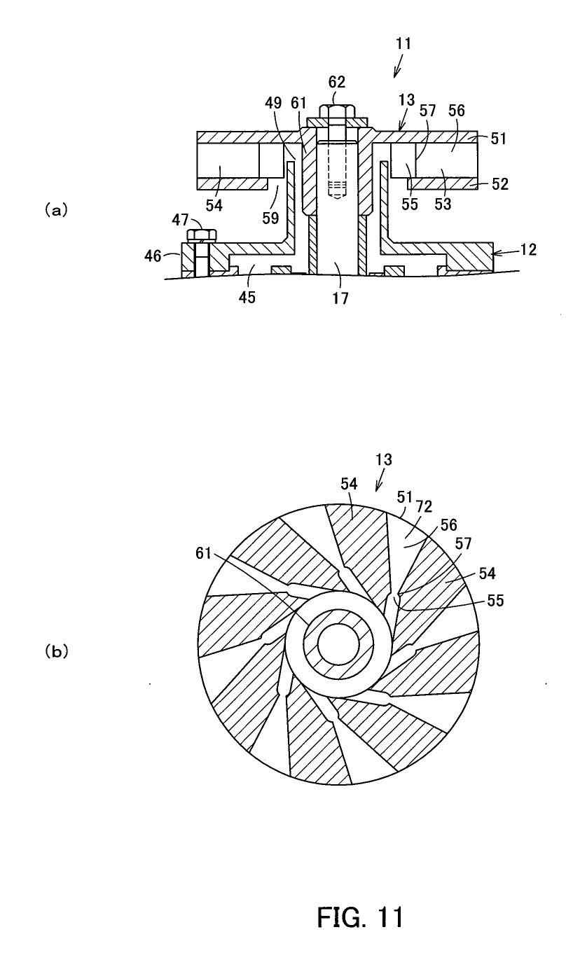

Next, an embodiment of the present invention is shown in FIG. 11, wherein FIG. 11 (a) is a sectional view illustrating the part where the rotation unit is provided, and FIG. 11 (b) is a bottom view illustrating the flow paths of the rotation unit.

According to the embodiment, the space between the disks 51,52 is partitioned by a plurality of centrifugal fins 54 so as to form a plurality of flow paths 53 open at the inner diameter side as well as the outer diameter side of the rotation unit 13. Each flow path 53 is provided with a flow path contraction portion 55, a minimum gap portion 57, and a flow path expansion portion 56.

While having a uniform dimension with respect to the axial cross section of the rotation unit 13, each flow path 53 has a flow path contraction portion 55 and a flow path expansion portion 56, at which the dimension of the flow path 53 respectively decreases and increases in a direction towards the outer diameter side with respect to the diametrical cross section of the rotation unit 13.

The structure described above is able to achieve the same functions and effects as can be done by the embodiment of the invention shown in FIG. 3.

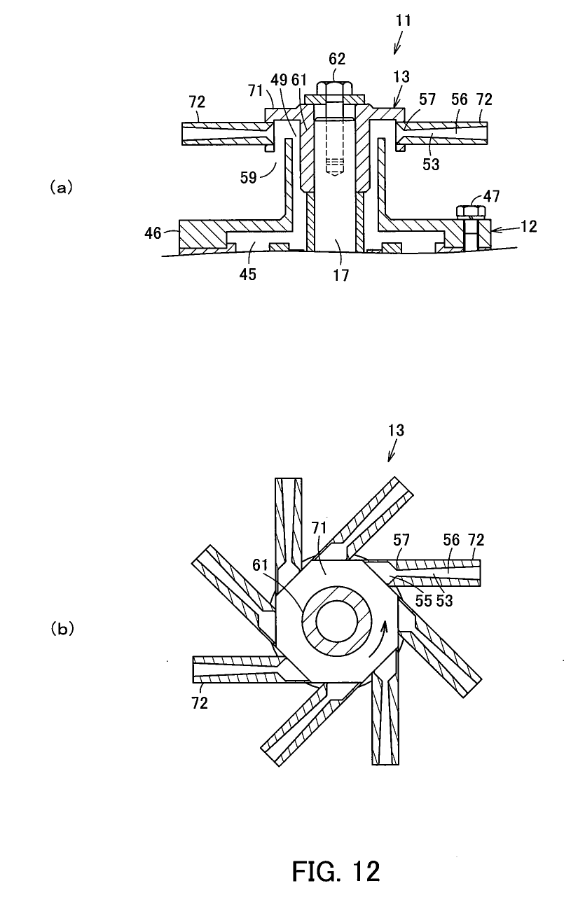

Next, an embodiment of the present invention is shown in FIG. 12, wherein FIG. 12 (a) is a sectional view illustrating the part where the rotation unit is provided, and FIG. 12 (b) is a bottom view illustrating the flow paths of the rotation unit.

According to the embodiment, the rotation unit 13 has a rotation unit body 71 and a plurality of Venturi tubes 72. The rotation unit body 71 has a boss 61 attached to the rotary shaft 17 of the canned motor 12. Each Venturi tube projects from the outer peripheral surface of the rotation unit body 71 in a direction opposite the direction of rotation of the rotation unit 13, which is indicated by the arrow in FIG. 12 (b), along a tangential line.

The rotation unit body 71 is provided with a liquid inlet 59 communicating with the interior of the Venturi tubes 72. Each Venturi tube 72 has a tubular flow path 53, which opens at the inner diameter side as well as the outer diameter side of the rotation unit 13 and includes a flow path reduction portion 55, a minimum gap portion 57, and a flow path expansion portion 56.

The structure as above produces a pump effect inside the Venturi tubes 72 for enabling a mixture of gas and liquid to flow therethrough and a stirring effect outside the Venturi tubes 72 for stirring the liquid in the tank 66.

Furthermore, the Venturi tubes 72 may have any outer shape that is a cylindrical, square, rectangular, or any polygonal shape having more than four sides. However, Venturi tubes with a tubular shape having a polygonal cross section are capable of improving the stirring effect for stirring the liquid in the tank 66.

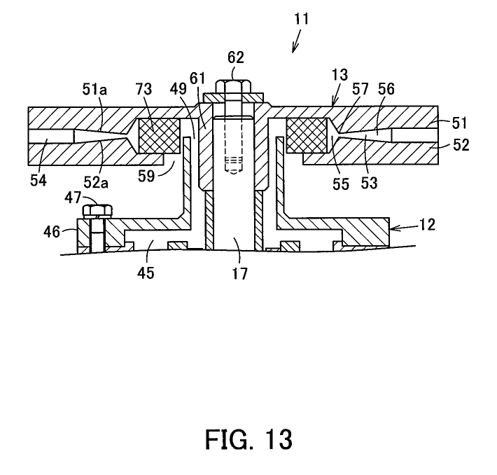

Next, yet another embodiment of the present invention is shown in FIG. 13, which is a sectional view illustrating the part where the rotation body is provided.

The embodiment has the same structure as found in the embodiment shown in FIG. 5, except that a metal mesh 73 that serves as a porous member is provided as a circumferentially uninterrupted band, at a location between the flow path expansion portion 56 and the inner diameter side of the rotation unit 13. The centrifugal fins 54 that are provided between the flow path expansion portion 56 and the inner diameter side in the embodiment shown in FIG. 5 may be omitted or provided as in the embodiment.

The gas introduced from the fluid inlet 48 is fed from the fluid outlet 49 into the central part of the rotation unit 13. The liquid in the tank 66 is introduced from the liquid inlet 59 of the rotation unit 13, which is being rotated by driving the canned motor 12. The mixture of the gas and the liquid subsequently is mixed at the metal mesh 73 and passes through the flow path contraction portion 55 and the flow path expansion portion 56 of the flow path 53 of the rotation unit 13 sequentially and is discharged out of the rotation unit 13.

In addition to ensuring satisfactory contact between the gas and the liquid when their mixture passes through the metal mesh 73, this structure presents a benefit in that centrifugal effect by the centrifugal fins 54 and the metal mesh 73 increases pressure in the diametrically inner part of the flow path 53 with respect to the flow path expansion portion 56, i.e. the part between the flow path expansion portion 56 and the inner diameter end of the flow path 53, thereby enabling pressure dissolution of the gas in the liquid. When the liquid containing the pressure-dissolved gas passes through the flow path 53, the drop in pressure causes the gas that is supersaturated in the liquid to be generated as microbubbles, and the liquid saturated with the dissolved gas is discharged.

In order to ensure a sufficient discharge rate from the rotation unit 13 provided with the metal mesh 73, it is desirable to enhance the centrifugal effect by, for example, arranging the centrifugal fins 54 at 45° intervals in the circumferential direction of the rotation unit 13.

Furthermore, what serves as the porous member is not limited to a metal mesh 73, and any other appropriate member, such as a plate with a plurality of holes formed therein may be used.

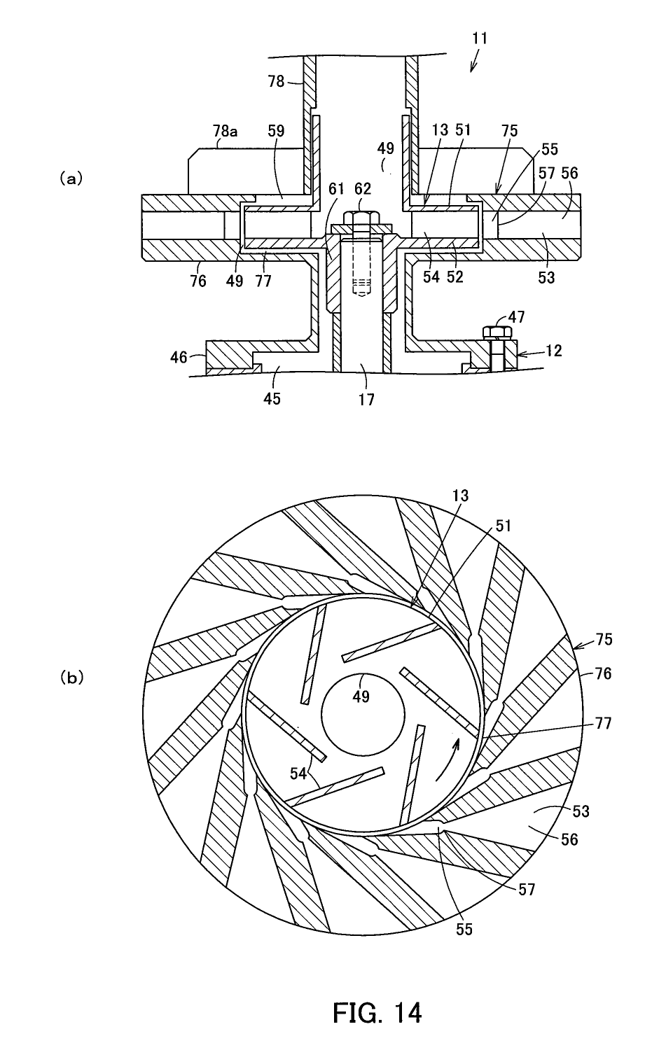

Next, another embodiment of the present invention is shown in FIG. 14, wherein FIG. 14 (a) is a sectional view illustrating the part where the rotation unit and a stationary unit are provided, and FIG. 14 (b) is a sectional view illustrating the flow paths of the rotation unit and the stationary unit viewed from the bottom side.

According to the embodiment, the stationary unit 75 is provided outside the outer circumferential surface of the rotation unit 13.

The rotation unit 13 includes two disks 51,52, which face each other and thereby form a flow path therebetween, and a plurality of centrifugal fins 54 provided between the disks 51,52. The central part of the disk 51, which is further from the canned motor 12 than is the disk 52, is open upward. The stationary unit 75 includes a stationary unit body 76, which is formed as an integral body and also serves as the fluid passage forming member 46. The stationary unit body has a rotation unit housing portion 77, in which the rotation unit 13 is rotatably positioned. The stationary unit body 76 has a plurality of flow paths 53 extending from the interior of the rotation unit housing portion 77 and are open at the outer diameter side of the stationary unit body 76. Each flow path 53 extends in a direction corresponding to the direction of rotation of the rotation unit 13, which is indicated by the arrow in FIG. 14 (b), along a tangential line. While having a uniform dimension with respect to the axial cross section, each flow path 53 has a flow path contraction portion 55 and a flow path expansion portion 56 at which the dimension of the flow path 53 respectively decreases and increases in a direction towards the outer diameter side with respect to the diametrical cross section. A liquid inlet 59 is formed at the upper part of the stationary unit 75. A pipe 78 is connected through a stay 78a to the upper part of the stationary unit 75. By a structure wherein the pipe 78 extends so that the upper end portion thereof reaches the upper part of the tank 66 and supported in that state, it is possible to feed the gas to the rotation unit 13 through the pipe 78. In other words, the gas may be fed to the rotation unit 13 from either one of or both the lower part of the rotation unit 13, at which the canned motor 12 is provided, and the upper part of the rotation unit 13, at which the pipe 78 is provided. When the gas is fed through the pipe 78, the aperture at the center of the disk 51, at which the lower end of the pipe 78 is located, serves as a fluid outlet 49 through which the gas introduced from above is introduced into the rotation unit 13.

The fluid passage 45 communicates with the flow paths 53 through the gap between the stationary unit body 76 and the disk 52 of the rotation unit 13. One other fluid outlet 49 is formed between the stationary unit body 76 and the outer circumferential part of the disk 52 of the rotation unit 13. With the structure as above, when the gas is introduced from the fluid inlet 48, the gas is fed through the fluid passage 45 into the diametrically outer part of the rotation unit 13. Or when the gas is introduced from the upper end of the pipe 78, the gas is fed through the pipe 78 into the diametrically inner part of the rotation unit 13.

When the rotation unit 13 rotates, the liquid in the tank 66 is sucked from the liquid inlet 59 of the rotation unit 13. As a result, the mixture of the gas and the liquid fed into the rotation unit 13 is discharged into the flow paths 53 of the stationary unit 75. When the mixture of the gas and the liquid passes through the flow path expansion portion 56 of each flow path 53, the change of the dimension of the flow path causes a change in the flow velocity, and consequently the pressure, of the gas-liquid mixture, resulting in micronization of the gas in the liquid.

Furthermore, a liquid inlet 59 for introducing the liquid from the tank 66 may be provided below the stationary unit 75.

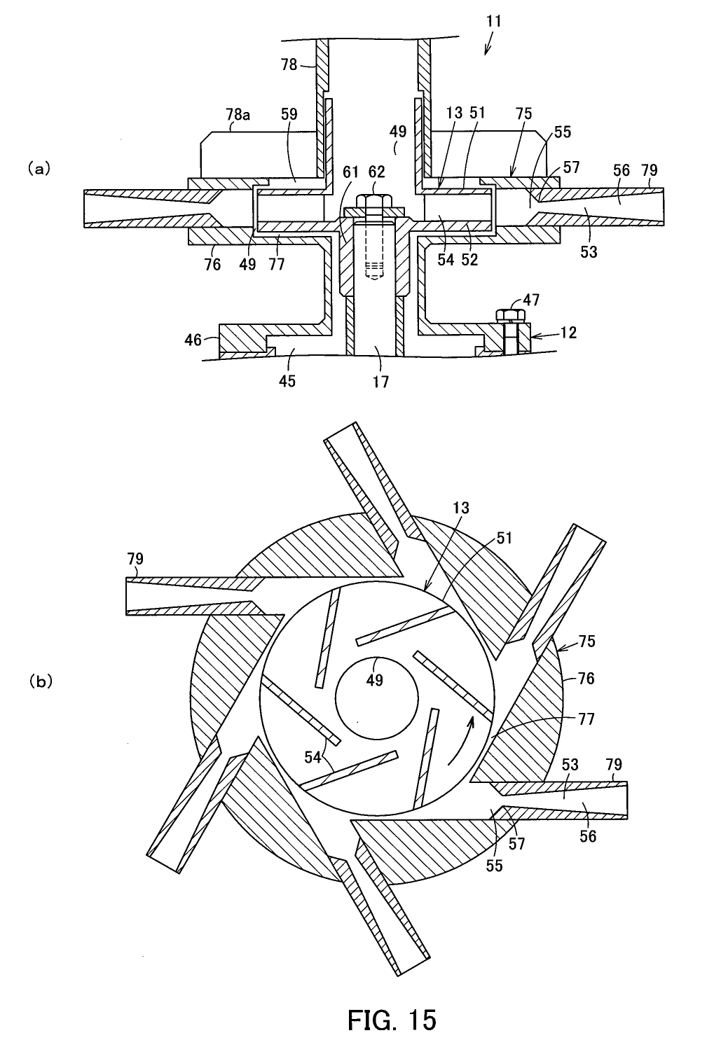

Next, a further embodiment of the present invention is shown in FIG. 15, wherein FIG. 15 (a) is a sectional view illustrating the part where the rotation unit and the stationary unit are provided, and FIG. 15 (b) is a sectional view illustrating the flow paths of the rotation unit and the stationary unit viewed from the bottom side.

The embodiment has the same structure as found in the embodiment shown in FIG. 14, except that the stationary unit has a plurality of Venturi tubes 79, each of which projects from the outer peripheral surface of the stationary unit body 76 in a direction corresponding to the direction of rotation of the rotation unit 13, which is indicated by the arrow in FIG. 15 (b), along a tangential line.

Each Venturi tube 79 has a flow path 53, which opens at the inner diameter side as well as the outer diameter side of the rotation unit 13 and includes a flow path contraction portion 55, a minimum gap portion 57, and a flow path expansion portion 56.

The structure described above is able to achieve the same functions and effects as can be done by the embodiment of the invention shown in FIG. 14.

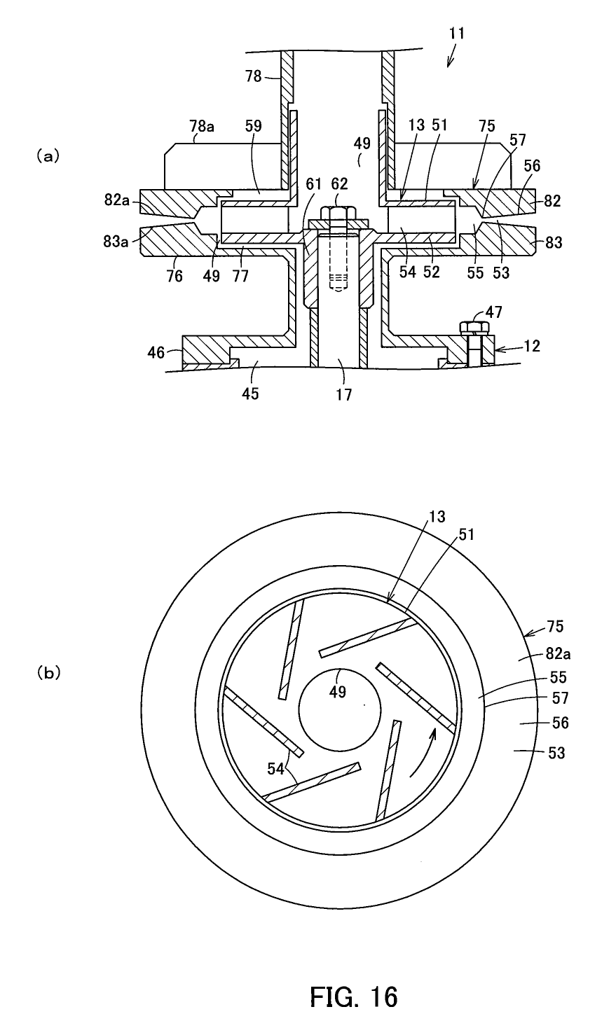

Next, an embodiment of the present invention is shown in FIG. 16, wherein FIG. 16 (a) is a sectional view illustrating the part where the rotation unit and the stationary unit are provided, and FIG. 16 (b) is a sectional view illustrating the flow paths of the rotation unit and the stationary unit viewed from the bottom side.

The embodiment has the same structure as found in the embodiment shown in FIG. 14, except that the stationary unit includes two disks 82,83, between which a circumferentially uninterrupted flow path 53 is formed. Tapered portions 82a,83a are formed on the opposing surfaces of the respective disks 82,83. The tapered portions 82a,83a are inclined so that the gap therebetween flares outward, towards the outer diameter end of the disks 82,83. As a result, the flow path 53 includes a flow path contraction portion 55, a minimum gap portion 57, and a flow path expansion portion 56.

The structure described above is able to achieve the same functions and effects as can be done by the embodiment of the invention shown in FIG. 14.

The flow path of the stationary unit 75 may be provided with one tapered portion (82a or 83a), which is provided on either one of the disks 82,83, as in the embodiment shown in FIG. 8.

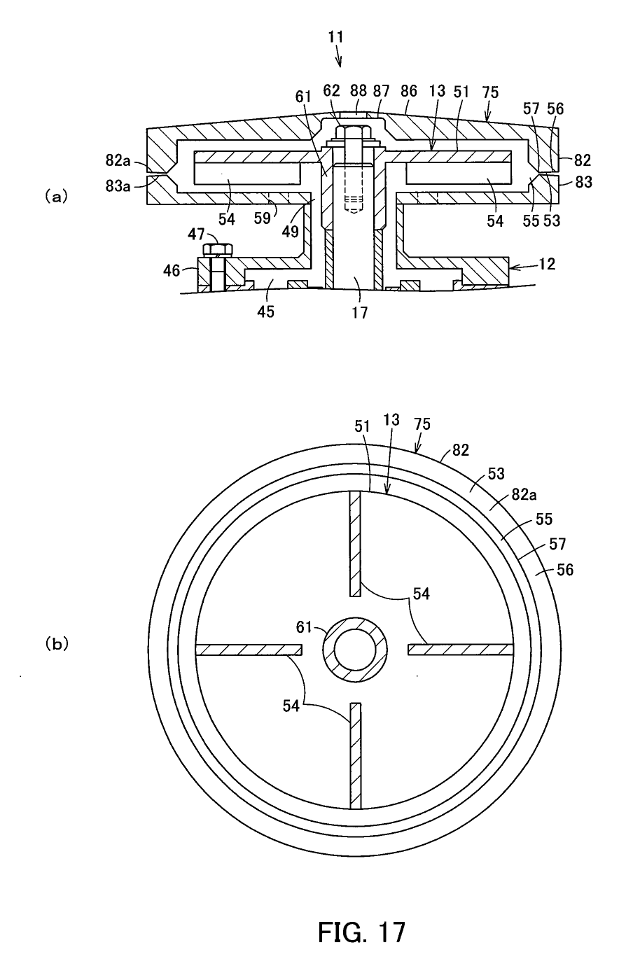

Next, an embodiment of the present invention is shown in FIG. 17, wherein FIG. 17 (a) is a sectional view illustrating the part where the rotation unit and the stationary unit are provided, and FIG. 17 (b) is a sectional view illustrating the flow paths of the rotation unit and the stationary unit viewed from the bottom side.

The embodiment has the same structure as found in the embodiment shown in FIG. 16, except that the upper disk 82 of the stationary unit 75 has a cover portion 86 for covering the top surface of the rotation unit 13 and that a plurality of liquid inlets 59 are formed near the inner circumferential portion of the lower disk 83. Formed at the central part of the cover portion 86 are an indented portion 87, which is formed in the bottom face of the cover portion 86, and a hole 88 that passes through the indented portion 87 and is open to the top surface of the cover portion 86. Another difference of the embodiment lies in that the rotation unit 13 includes one of the disks, i.e. the disk 51, and a plurality of centrifugal fins 54.

In cases where a dispersion tank 65 is equipped with a dispersion/stirring apparatus 11 having a structure described above, the tank 66 is empty at the initiation of the process, and when the liquid begins to be fed into the tank 66 to be retained therein, the gas remaining in the stationary unit 75 of the dispersion/stirring apparatus 11 can be discharged out of the stationary unit 75 from the hole 88. As a result, it is possible to prevent the generation of cavitation or failure of function of the rotation unit 13, which would otherwise occur due to the gas remaining in the stationary unit 75 during operation of the dispersion/stirring apparatus 11.

Furthermore, should an excessive quantity of the gas be introduced from the liquid inlet 48 into the stationary unit 75, the excess gas that cannot be dissolved or dispersed in the liquid flows out of the stationary unit 75 from the hole 88 of the stationary unit 75. Therefore, it is possible to monitor an appropriate amount of the supply of gas by visually ascertaining whether gas flows out of the hole 88. If it appears that gas is flowing out of the hole 88, supply of the gas can be appropriately adjusted so that no excess gas will flow out. This feature is effective in preventing various problems, such as cavitation as well as malfunction of the rotation unit 13, that are prone to occur in case of excessive supply of gas.

In any one of the embodiments shown in FIGS. 1 to 13, the same function and effects as those performed by the hole 88 formed in the stationary unit 75 described above can be achieved by a hole that communicates with the interior and the exterior of the rotation unit 13 and is formed at a location in the proximity of the center (for example, outside the boss 61 or at the boss 61) of the disk 51, which is the upward-facing end of the rotation unit 13.

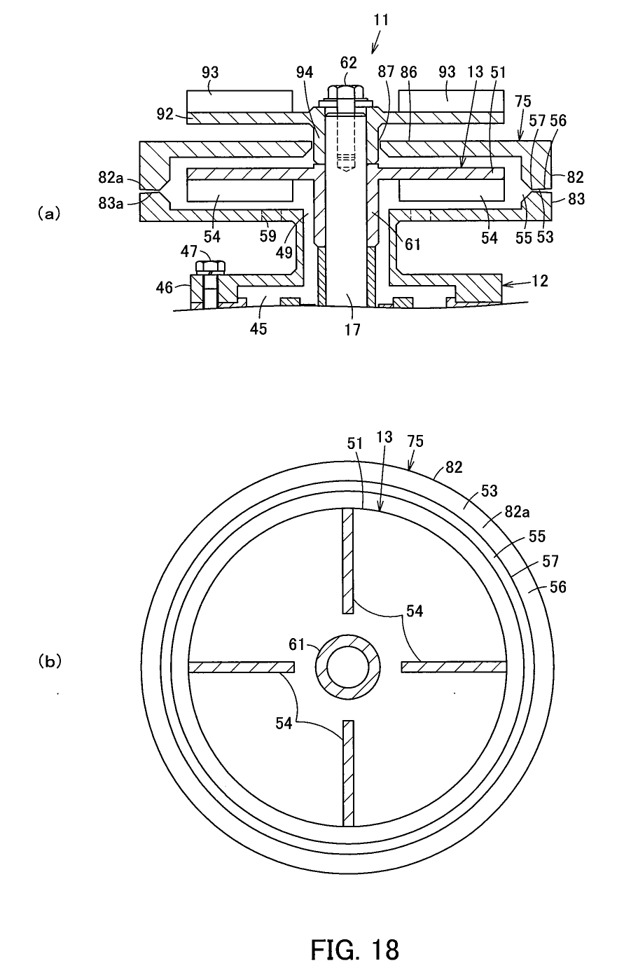

Next, a further embodiment of the present invention is shown in FIG. 18, wherein FIG. 18 (a) is a sectional view illustrating the part where the rotation unit and the stationary unit are provided, and FIG. 18 (b) is a sectional view illustrating the flow paths of the rotation unit and the stationary unit viewed from the bottom side.

The embodiment has the same structure as found in the embodiment shown in FIG. 17, except that the rotary shaft 17 of the canned motor 12 extends to such a location as to pass through the stationary unit 75 and that a stirring fin unit 91 is attached to the front end of the rotary shaft 17 and adapted to rotate, outside the stationary unit 75, integrally with the rotation unit 13.

The stirring fin unit 91 includes a disk 92. A plurality of radially arranged stirring fins 93 are provided on and project from the externally facing planar surface of the disk 92, i.e. the surface facing away from the stationary unit 75. A boss 94 attached to the rotary shaft 17 of the canned motor 12 is formed at the central part of the disk 92. The stirring fin unit 91 is fastened, together with the rotation unit 13, to the front end of the rotary shaft 17 of the canned motor 12 by fastening a bolt 62.

Therefore, the stirring fins 93 of the stirring fin unit 91, which is adapted to rotate outside the stationary unit 75 integrally with the rotation unit 13, enables, without the need of a separate stirring device, greater reliability for stirring the gas-containing liquid in the tank 66.

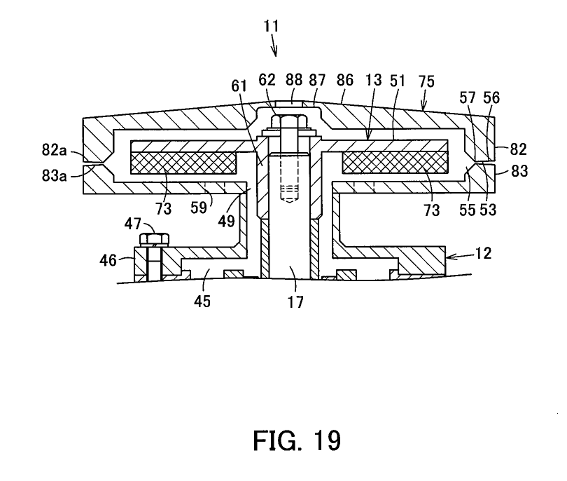

Next, an embodiment of the present invention is shown in FIG. 19, which is a sectional view illustrating the part where the rotation body and the stationary unit are provided. The embodiment has the same structure as found in the embodiment shown in FIG. 17, except that a metal mesh 73 that serves as a porous member is provided as a circumferentially uninterrupted band. The centrifugal fins of the rotation unit 13, which are provided in the embodiment shown in FIG. 17 may be omitted or provided as in the embodiment.

As a result of driving the canned motor 12, the rotation unit 13 rotates so that the gas introduced from the fluid inlet 48 is fed from the fluid outlet 49 into the central part of the rotation unit 13. The rotation unit 13 being rotated by driving the canned motor 12 causes the liquid in the tank 66 to be introduced from the liquid inlet 59 of the stationary unit 75. The mixture of the gas and the liquid subsequently is mixed at the metal mesh 73 of the rotation unit 13 and passes through the flow path reduction portion 55 and the flow path expansion portion 56 of the flow path 53 of the stationary unit 75 sequentially and is discharged out of the stationary unit 75.

In addition to ensuring satisfactory contact between the gas and the liquid when their mixture passes through the metal mesh 73, this structure presents a benefit in that centrifugal effect by the metal mesh 73 increases pressure in the diametrically inner part of the flow path 53 with respect to the flow path expansion portion 56, i.e. the part between the flow path expansion portion 56 and the inner diameter end of the flow path 53, thereby enabling pressure dissolution of the gas in the liquid. When the liquid containing the pressure-dissolved gas passes through the flow path 53, the drop in pressure causes the gas that is supersaturated in the liquid to be generated as microbubbles, and the liquid saturated with the dissolved gas is discharged.

The application of the metal mesh 73 is not limited to the structure described above, wherein the rotation unit 13 is provided with the metal mesh 73. The metal mesh 73 may be provided at a location between the inner diameter side and the flow path expansion portion 56 of the flow path 53 of the stationary unit 75. Furthermore, both the rotation unit 13 and the stationary unit 75 may respectively be provided with a metal mesh 73.

Furthermore, what serves as the porous member is not limited to a metal mesh 73, and any other appropriate member, such as a plate with a plurality of holes formed therein may be used.

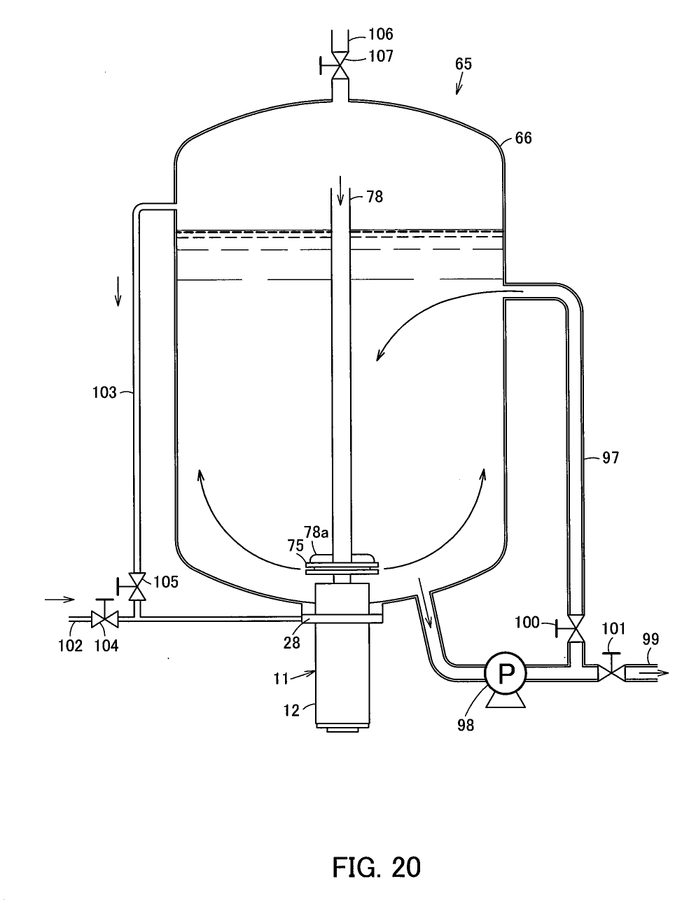

Next, another embodiment of the present invention is shown in FIG. 20, which is a sectional view of a dispersion tank. According to the embodiment, an external cyclic path 97 connecting the bottom portion and the upper part of the side of the tank 66 is provided. The external cyclic path 97 is provided with a pump 98 that serves to introduce the liquid from the bottom of the tank 66 into the external cyclic path 97 and return the liquid from the external cyclic path 97 to the upper side of the tank 66, thereby circulating the liquid.

A delivery path 99 is connected to the discharge side of the pump 98 of the external cyclic path 97 and serves to deliver to a next process a part of the gas-containing liquid in the external cyclic path 97 introduced from the tank 66. The external cyclic path 97 and the delivery path 99 are respectively provided with valves 100,101, which are respectively provided downstream from the point where the external cyclic path 97 and the delivery path 99 are connected. Flow rate adjustment by these valves 100,101 enables adjustment of delivery amount of the gas-containing liquid from the delivery path 99.

By operating the pump 98 so as to introduce the gas-containing liquid from the bottom of the tank 66 into the external cyclic path 97 and return the liquid into the upper part of the tank 66, the gas-containing liquid in the tank 66 can be stirred and mixed.

Therefore, the external cyclic path 97 in addition to the stirring function of the dispersion/stirring apparatus 11 enables more reliable stirring of the gas-containing liquid in the tank 66.

Furthermore, the delivery path 99 enables a part of the gas-containing liquid that has been introduced from the tank 66 into the external cyclic path 97 to be delivered to a next process. At that time, connecting the delivery path 99 to the external cyclic path 97 enables the use of discharge pressure by the pump 98 for delivery of the liquid containing the gas.

As there are two or more kinds of fluids in the tank 66, the liquid is retained in the lower part of the tank 66, while the gas that cannot be dispersed in the liquid separates from the liquid resulting from the difference in specific gravity and is retained in the upper part of the tank 66. Connected to the fluid inlet 48 of the dispersion/stirring apparatus 11 are a fluid supply path 102 and a fluid cyclic path 103, which are respectively provided with valves 104,105. The fluid supply path 102 serves to feed pressurized gas from the outside. The fluid cyclic path 103 shares a part of the fluid supply path 102 and serves to return the gas in the upper part of the tank 66 to the dispersion/stirring apparatus 11.

A gas discharge path 106 for discharging the gas to the outside is connected to the upper part of the tank 66. The gas discharge path 106 is provided with a valve 107.

With the structure as above, the gas can be fed to the dispersion/stirring apparatus 11 through the fluid supply path 102, while self-suction function resulting from rotation of the rotation unit 13 of the dispersion/stirring apparatus 11 enables the gas in the upper part of the tank 66 to be returned to the dispersion/stirring apparatus 11 through the fluid cyclic path 103 so as to be dispersed and stirred into the liquid in the tank 66. Therefore, as reuse of the gas to be dispersed is possible, the consumption efficiency of the gas to be dispersed is improved, resulting in improved efficiency of the entire system.

Furthermore, in cases where a dispersion/stirring apparatus having a structure according to any one of the embodiments from the thirteenth to the fifteenth embodiments shown in FIGS. 14 to 16, the pipe 78 fixed to the stationary unit 75 of the dispersion/stirring apparatus 11 is arranged so that the upper end of the pipe 78 is positioned in the area of the upper part of the tank 66 where the gas is retained. With the structure as above, self-suction function resulting from rotation of the rotation unit 13 of the dispersion/stirring apparatus 11 enables the gas in the upper part of the tank 66 to be returned to the dispersion/stirring apparatus 11 through the pipe 78 so as to be dispersed and stirred into the liquid in the tank 66. As a result, the pipe 78, too, functions as a fluid cyclic path 103.

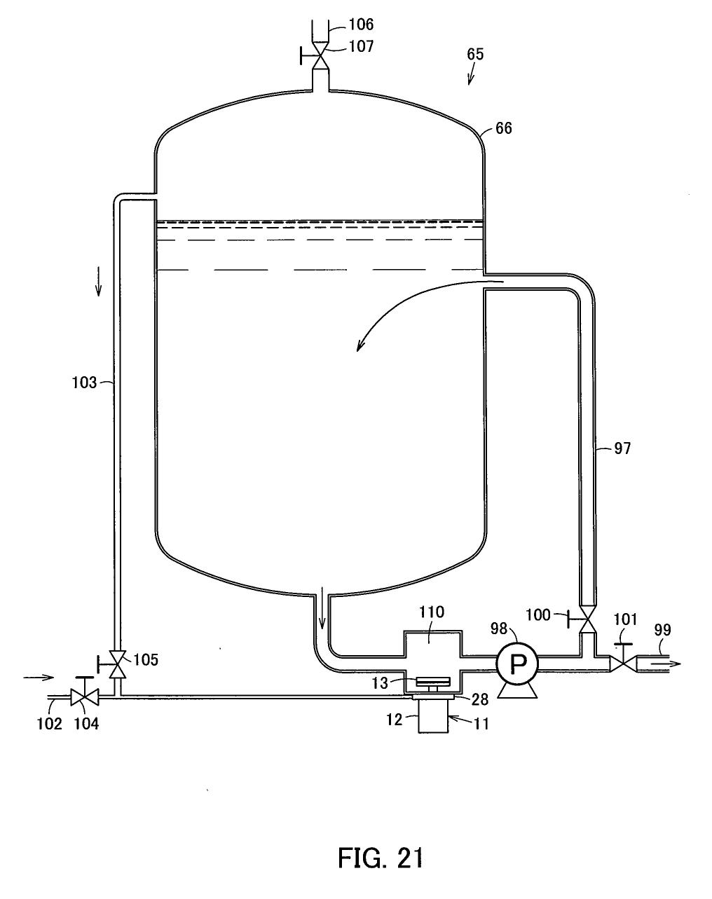

Next, a embodiment of the present invention is shown in FIG. 21, which is a sectional view of a dispersion tank. The embodiment has the same structure as found in the embodiment shown in FIG. 20, except that the fluid cyclic path 97, instead of the tank 66, is provided with the dispersion/stirring apparatus 11. To be more specific, a dispersion/stirring chamber 110 is formed at some point along the length of the fluid cyclic path 97, between the pump 98 and the bottom of the tank 66, and the rotation unit 13 of the dispersion/stirring apparatus 11 is positioned in the dispersion/stirring chamber 110.

By operating the pump 98 so as to introduce the liquid from the bottom of the tank 66 into the external cyclic path 97 and return the liquid into the upper part of the tank 66, the gas-containing liquid in the tank 66 can be stirred and mixed.

At that time, the dispersion/stirring apparatus 11 is capable of dispersing and stirring the gas into the liquid introduced into the fluid cyclic path 97.

Furthermore, in cases where a part of the gas-containing liquid that has been introduced from the tank 66 into the external cyclic path 97 is delivered through the delivery path 99 to a next process, the dispersion/stirring apparatus disperses the gas into the liquid introduced into the fluid cyclic path 97 and stirs the resultant mixture, thereby ensuring reliable dispersion of the gas as well as delivery of the liquid containing the dispersed gas into the delivery path 99.

A dispersion/stirring apparatus 11 that is provided with a rotation unit 13 and a stationary unit 75 may serve as the dispersion/stirring apparatus 11 used for this embodiment. The shapes of the flow path of the rotation unit 13 or the stationary unit 75 of the dispersion/stirring apparatus 11 according to the present invention are not limited to those explained as above referring to the embodiments of the invention, and any shape is permissible, provided that the flow path expansion portion 56 can be formed.

For example, it is not essential to provide the flow path 53 with a flow path contraction portion 55. In another alternative structure, a passage portion having the same dimension as that of the minimum gap portion 57 may be provided in the diametrically inner part of the flow path 53. It is also possible to provide a plurality of flow path expansion portions 56 in series arranged in a diametrical direction of the flow path 53 so as to increase even further the degree of micronization of the gas passing through the flow path 53. Furthermore, in cases where the rotation unit 13 is provided with the flow path 53, the flow path 53 may be formed diagonally so that a discharge port at the outer circumferential side of the flow path 53 is open at the outer diameter end of the disk 51 of the rotation unit 13. It is also possible to provide a single rotary shaft 17 of the dispersion/stirring apparatus 11 with a plurality of rotation units 13 or a plurality of rotation units 13 and stationary units 75. If such is the case, the quantity of the gas to be dispersed and stirred into the liquid can be increased.

The structure for feeding the fluid to the rotation unit 13 is not limited to those explained as above referring to the embodiments of the invention, and any structure is permissible, provided that the fluid can be fed without any problems.

The flow path 53 may be provided with, in the place of Venturi tubes, any other appropriate member, such as an orifice unit having numerous holes formed in the entire circumferential surface thereof, to micronize the gas.

The application of the dispersion/stirring apparatus 11 and the dispersion tank 65 having structures described above is not limited to dispersing and stirring a second fluid into a first fluid retained in the tank 66, wherein the first fluid may be a liquid, and the second fluid is different from the first fluid and contains at least one fluid that is a gas, a liquid that is not soluble with the liquid in the tank 66, or a liquid that contains bubbles. The dispersion/stirring apparatus 11 and the dispersion tank 65 are also applicable to dispersion of secondary particles, i.e. aggregations of primary particles, in a suspension liquid into primary particles, or micronization of liquid droplets in a dispersion liquid.

The present invention is applicable to, for example, dispersing and stirring a second fluid into a first fluid.

1. A dispersion/stirring apparatus comprising a rotation unit, and including:
a flow path open at an inner diameter side as well as an outer diameter side of the rotation unit, thereby enabling fluid communication of the exterior and the interior of the rotation unit; and
a flow path expansion portion provided so that the flow path expands in a direction towards the outer diameter side of the rotation unit.

2. A dispersion/stirring apparatus as claimed in claim 1, wherein:
the rotation unit comprises a plurality of disks that face one another; and
the flow path and the flow path expansion portion are provided between the disks.

3. A dispersion/stirring apparatus as claimed in claim 1, wherein:
the dispersion/stirring apparatus includes a fixed member facing the rotation unit; and
the flow path and the flow path expansion portion are provided between the rotation unit and the fixed member.

4. A dispersion/stirring apparatus as claimed in claim 1, wherein:
the flow path is provided with a porous member at a location between the flow path expansion portion and the inner diameter side of the rotation unit.

5. A dispersion/stirring apparatus as claimed in claim 1, wherein:
the rotation unit is provided with a centrifugal fin between either the inner diameter side and the flow path expansion portion or the outer diameter side and the flow path expansion portion, or between the inner diameter side and the flow path expansion portion, as well as between the outer diameter side and the flow path expansion portion.

6. A dispersion/stirring apparatus as claimed in claim 1, wherein:
an end of the rotation unit faces upward and is provided with a hole that communicates with the interior and the exterior of the rotation unit.

7. A dispersion/stirring apparatus comprising a rotation unit and a stationary unit that is provided outside the outer diameter side of the rotation unit, the dispersion/stirring apparatus including:
a flow path open at an inner diameter side as well as an outer diameter side of the stationary unit, thereby enabling fluid communication of the exterior and the interior of the stationary unit; and
a flow path expansion portion provided so that the flow path expands in a direction towards the outer diameter side of the stationary unit.

8. A dispersion/stirring apparatus as claimed in claim 7, wherein:
either one of or both the rotation unit and the stationary unit are provided with a porous member, with the porous member provided in the stationary unit being positioned between the flow path expansion portion of the flow path and the inner diameter side of the stationary unit.

9. A dispersion/stirring apparatus as claimed in claim 7, wherein:
the stationary unit covers the rotation unit; and
a hole is formed in the top surface of the stationary unit.

10. A dispersion/stirring apparatus as claimed in claim 7, wherein:
the dispersion/stirring apparatus includes a stirring fin provided outside the stationary unit and adapted to rotate integrally with the rotation unit.

11. A dispersion/stirring apparatus as claimed in claim 1, wherein:
the dispersion/stirring apparatus includes a stirring fin provided on the outer surface of the rotation unit.

12. A dispersion/stirring apparatus as claimed in claim 1, wherein:
the dispersion/stirring apparatus includes a canned motor for rotating the rotation unit.

13. A dispersion tank comprising:
a tank for retaining a fluid; and
a dispersion/stirring apparatus as claimed in claim 12, the dispersion/stirring apparatus being provided at least at the bottom or the side of the tank and adapted to disperse and stir into the fluid retained in the tank a fluid that is different from the fluid retained in the tank.

14. A dispersion tank as claimed in claim 13, wherein the dispersion tank includes:
an external cyclic path for removing the fluid retained in the tank out of the tank and returning the removed fluid into the tank; and
a pump for circulating the fluid retained in the tank to the external cyclic path.

15. A dispersion tank comprising:
a tank for retaining a fluid;
an external cyclic path for removing the fluid retained in the tank out of the tank and returning the removed fluid into the tank; and
a pump for circulating the fluid retained in the tank to the external cyclic path; and
a dispersion/stirring apparatus as claimed in claim 12, the dispersion/stirring apparatus being provided in the external cyclic path and adapted to disperse and stir into the fluid circulating through the external cyclic path a fluid that is different from the fluid circulating through the external cyclic path.

16. A dispersion tank as claimed in claim 14, wherein the dispersion tank includes:
a delivery path for delivering to a next process a part of the fluid discharged from the tank into the external cyclic path.

17. A dispersion tank as claimed in claim 13, wherein the dispersion tank includes:
a fluid supply path for supplying the dispersion/stirring apparatus with a fluid that is different from and has a specific gravity lower than that of the fluid retained in the tank; and
a fluid cyclic path for returning to the dispersion/stirring apparatus a fluid that is different from and has separated upward from the fluid retained in the tank.

18. A dispersion/stirring apparatus as claimed in claim 7, wherein:
the dispersion/stirring apparatus includes a stirring fin provided on the outer surface of the rotation unit.

19. A dispersion/stirring apparatus as claimed in claim 7, wherein:
the dispersion/stirring apparatus includes a canned motor for rotating the rotation unit.

20. A dispersion tank comprising:
a tank for retaining a fluid; and
a dispersion/stirring apparatus as claimed in claim 19, the dispersion/stirring apparatus being provided at least at the bottom or the side of the tank and adapted to disperse and stir into the fluid retained in the tank a fluid that is different from the fluid retained in the tank.

21. A dispersion tank as claimed in claim 20, wherein the dispersion tank includes:
an external cyclic path for removing the fluid retained in the tank out of the tank and returning the removed fluid into the tank; and
a pump for circulating the fluid retained in the tank to the external cyclic path.
